(19) United States
(12) Patent Application Publication
(10) Pub. No.: US 2002/0080315 A1
(43) Pub. Date: Jun. 27, 2002

(54) Liquid crystal display apparatus and method for checking the joining accuracy thereof

(76) Inventor: Ming-Cheng Tsai, Tainan Hsien (TW)

Correspondence Address: Chien-Wei (Chris) Chou, Esq., OPPENHEIMER WOLFF & DONNELLY LLP, Suite 300, 101 Park Center Plaza, San Jose, CA, 95113, US

(21) Appl. No.: 09/993,433

(22) Filed: Nov. 13, 2001

(30) Foreign Application Priority Data
Dec. 26, 2000 (TW) 89127861

(51) Int. Cl. G02F 1/1345

(52) U.S. Cl. 349/149

(57) ABSTRACT

The present invention provides an LCD apparatus and a method for checking the joining accuracy thereof. The LCD apparatus comprises an LCD panel, a printed circuit board and a package unit coupled to the LCD panel. On the printed circuit board, there is a coupling region that comprises a plurality of first pins and the coupling region comprises at least one transparent area with at least one first pin. The package unit is coupled to the LCD panel and with a plurality of second pins thereon corresponding to the first pins, wherein the second pins are electrically joined to the first pins. When the first pins and the second pins are joined together by anisotropic conductive film or solder, the joining accuracy can be checked through the transparent area on the printed circuit board.

### FIELD OF THE INVENTION

The present invention relates to a liquid crystal display, and more particularly to an improved liquid crystal display apparatus and method for checking the joining accuracy thereof.

### BACKGROUND OF THE INVENTION

Conventionally, a liquid crystal display apparatus comprises a panel, a drive circuit and a control circuit. The pixels on the panel are driven by the drive circuit and the control circuit is designed to manipulate the drive circuit to control images displayed on the panel. In a liquid crystal display apparatus, the drive circuit is generally set on tape carrier packages (TCP) and the control circuit is laid out on a control circuit board. The TCP is coupled to the panel and the control circuit is coupled to the TCP, wherein the pins on the control circuit are constrained in a predetermined ring to correspond with pins on the TCP to maintain the display quality of the liquid crystal apparatus. Therefore, there is a need to check the joining accuracy of the pins to ensure the quality of the LCD. FIG. 1 shows the conventional method for checking joining accuracy of the pins on the control circuit board and the LCD panel of an LCD apparatus. TCP 1 is coupled to the control circuit 2, and it is difficult to observe the pins 3 on the control circuit 2 because TCP 1 blocks them. One way to check the joining accuracy of the pins is to cut a detection window 5 along the edge of TCP 1 to expose one pin 3 on the control circuit 2 for comparison with the corresponding pin 4 on TCP. All of the pins 3 and 4 are parallel and the pins 3 on the control circuit are designed to correspond with the pins 4 on TCP. If the exposed pin 3 in the detection window 5 is joined to the corresponding pin 4 approximately, the rest of pins match as well.

Conventionally, the pins 3 on the control circuit are joined to the pins 4 on TCP with solder. However, anisotropic conductive film (ACF) has become popular for joining the pins. When the anisotropic conductive film (ACF) is used to join the pins 3 on the control circuit to the pins 4 on TCP, the adhesive resins that are squeezed out will block the observation through the detection window 5. Therefore, it is not easy to check the joining accuracy of the pins when the anisotropic conductive film is chosen to join the pins 3 and 4.

### SUMMARY OF THE INVENTION

An object of the present invention is to provide an improved liquid crystal display apparatus to easily check the joining accuracy of the pins on a control circuit board and a package unit.

Another object of the present invention is to provide a method for checking the joining accuracy of pins on a control circuit board and a package unit of an LCD apparatus by observing through a transparent area on the circuit board.

To achieve these advantages, a liquid crystal display (LCD) apparatus comprises an LCD panel, a printed circuit board and a package unit coupled to the LCD panel.

On the printed circuit board, there is a coupling region that comprises a plurality of first pins and the coupling region comprises at least one transparent area with at least one first pin.

The package unit is coupled to the LCD panel with a plurality of second pins thereon corresponding to the first pins, wherein the second pins are electrically joined to the first pins by conductive material.

In another aspect of the present invention is to provide a method of checking the joining accuracy of pins on a control circuit board and a package unit of an LCD apparatus comprising the steps of:

providing a transparent area on at least one segment of the coupling region of the printed circuit board and at least one first pin within the transparent area; and

checking the joining accuracy of the fist pin and the corresponding second pin through the transparent area.

According to another aspect of the present invention, the package unit is a tape carrier package (TCP) and the package unit further comprises a driving circuit thereon for driving the LCD panel. The printed circuit board further comprises a control circuit thereon for controlling the driving circuit. The first pins on the printed circuit board can be joined with the second pins on the package unit by anisotropic conductive film (ACF) or solder.

### BRIEF DESCRIPTION OF THE DRAWINGS

The above objects and other advantages of the present invention will become more apparent by describing in detail a preferred embodiment thereof which reference to the attached drawings in which:

FIG. 1 is a schematic drawing illustrating the conventional design for checking joining accuracy of the pins on the control circuit board and the LCD panel;

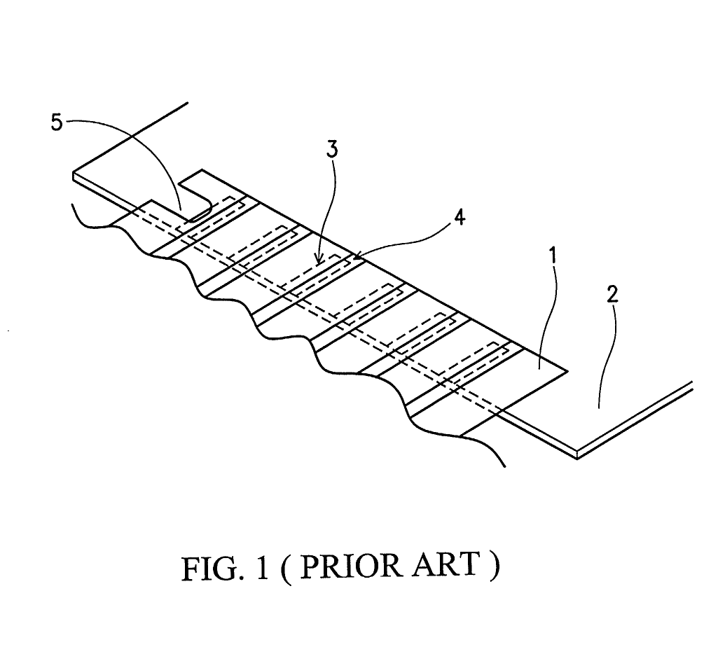

FIG. 2 is a schematic drawing illustrating the pins joining within an LCD apparatus according to one embodiment of the present invention;

FIG. 3 is a side view illustrating an LCD apparatus when checking the joining accuracy according to one embodiment of the present invention;

FIG. 4 is the method flowchart of checking joining accuracy of an LCD apparatus according to one embodiment of the present invention.

### DETAILED DESCRIPTION OF THE INVENTION

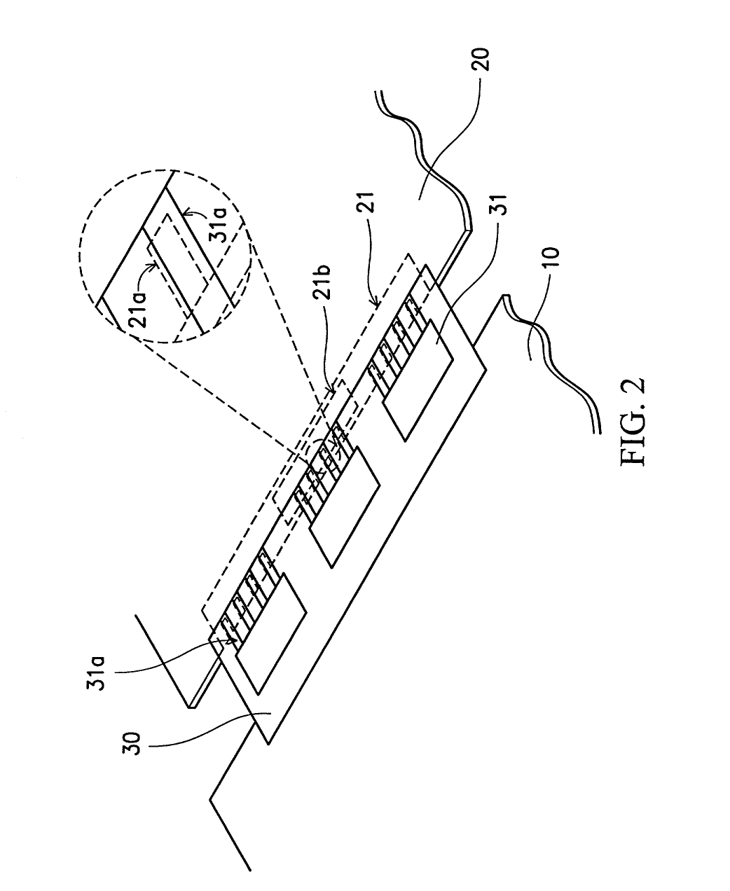

FIG. 2 shows an LCD apparatus 100 according to one embodiment of the present invention. The LCD apparatus 100 comprises an LCD panel 10, a printed circuit board 20 and tape carrier package (TCP) 30. There are a coupling region 21 comprising a plurality of first pins 21a and a control circuit (not shown) on the printed circuit board 20. There is at least one segment on the coupling region 21 is transparent and at least one first pin is within the transparent area 21b. In FIG. 2, there are four first pins 21a within the transparent area 21b on the coupling region 21 of the LCD panel 10. In a preferred embodiment, there is no other circuit laid on the transparent area 21b except the fist pins 21a. The circuit laid on the transparent area 21b, such as a wide area copper as ground wire on the opposite side of the printed circuit board 20, will block the observation of the joining the first pins 21a and second pins 31a.

On the tape carrier package (TCP) 30 in FIG. 2, there are driving circuits 31 for diving the LCD panel 10, and a plurality of second pins 31a that is designed for joining to the first pins on the printed circuit board 20 correspondingly. The tape carrier package 30 is coupled to the LCD panel 10 and the second pins 31a thereon are joined to the first pins 21a to assemble the tape carrier package 30 and the printed circuit 20. The first pins 21a and the second pins 31a are joined together by anisotropic conductive film or solder. The amount of the tape carrier packages 30 and the second pins 31a thereon depends on the number of pixels displayed in the LCD panel 10's selected resolution.

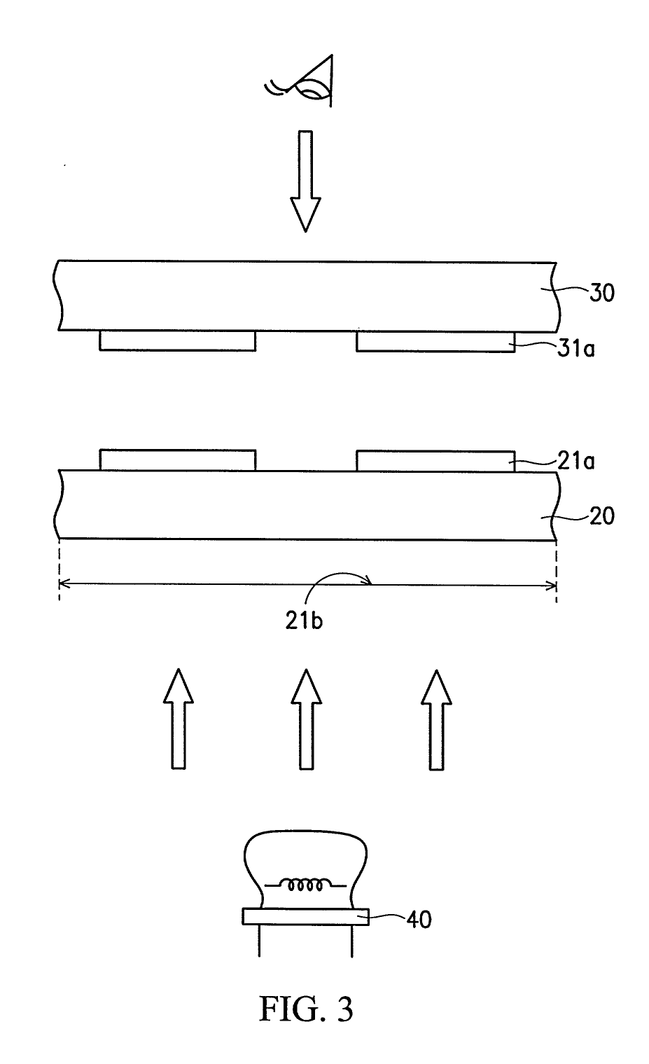

As illustrated in FIG. 3, the joining accuracy of an LCD apparatus is observed through the transparent area 21b in one embodiment of the present invention. When the first pins 21a and the second pins 31a are joined together by anisotropic conductive film or solder, the joining accuracy can be observed from the top of TCP 30 that is right above the transparent area 21b by projecting a light 40 to penetrate the transparent area 21b. If the second pins 31a are not joined right above the first pins 21a precisely, the shadows of non-overlapping area of the second pins 31a project onto the transparent area 21b.

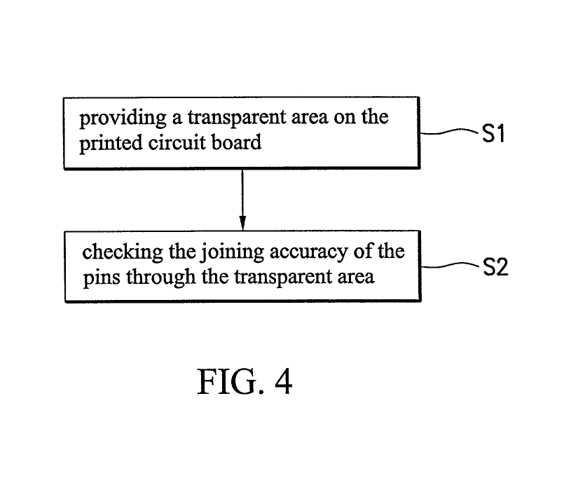

As illustrated FIG. 4, the method of checking the joining accuracy of an LCD apparatus first comprises the step S1: providing a transparent area on the printed circuit board 20, wherein the transparent area 21b is on a coupling region on the circuit board 20 and there is at least one first pin 21a within the transparent area 21b. And then perform step S2: checking the joining accuracy through the transparent area. Since the pins on the LCD apparatus are tiny and dense, a microscope can be used to checking the joining accuracy and the shift of the second pins 31a can be measured by a ruler inside the microscope.

It is simple and quick to check the joining accuracy of an LCD apparatus according to the present invention. If the second pins 31a are not joined with the first pins 21a correspondingly, the joining quality of the pins 21a and 31a of the LCD apparatus is not qualified.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A liquid crystal display (LCD) apparatus, comprising:
an LCD panel;
a printed circuit board with a coupling region which comprises a plurality of first pins thereon, wherein at least one segment of the coupling region comprises a transparent area and at least one first pin within the transparent area; and
a package unit coupled to the LCD panel with a plurality of second pins thereon corresponding to the first pins, wherein the second pins are electrically joined to the first pins and the joining accuracy is observed through the transparent area.

2. The LCD apparatus as claimed in claim 1, wherein the package unit is a tape carrier package(TCP).

3. The LCD apparatus as claimed in claim 2, wherein the package unit comprises a driving circuit thereon for driving the LCD panel.

4. The LCD apparatus as claimed in claim 3, wherein the printed circuit board comprises a control circuit thereon for controlling the driving circuit.

5. The LCD apparatus as claimed in claim 4, wherein the second pins are electrically connected to the first pins by an anisotropic conductive film (ACF).

6. The LCD apparatus as claimed in claim 4, wherein the second pins are electrically connected to the first pins by solder.

7. A method for checking joining accuracy of a plurality of first pins on a coupling region of a printed circuit board and a plurality of second pins on a package unit, wherein the package unit is coupled to an LCD panel with the second pins thereon corresponding to the first pins for electrically connecting printed circuit board and the LCD panel, the method comprising the steps of:
providing a transparent area on at least one segment the coupling region and at least one first pin within the transparent area; and
checking the joining accuracy of the fist pin and the corresponding second pin through the transparent area.

8. The method as claimed in claim 7, wherein the package unit is a tape carrier package (TCP).

9. The method as claimed in claim 8, wherein the package unit comprises a driving circuit thereon for driving the LCD panel.

10. The method as claimed in claim 9, wherein the printed circuit board comprises a control circuit thereon for controlling the driving circuit.

11. The method as claimed in claim 10, wherein the second pins are electrically connected to the first pins by an anisotropic conductive film (ACF).

12. The method as claimed in claim 10, wherein the second pins are electrically connected to the first pins by solder.
